(19) United States
(12) Patent Application Publication
(10) Pub. No.: US 2022/0196047 A1
(43) Pub. Date: Jun. 23, 2022

(54) CLAMP

(71) Applicant: NINGBO GALAXY IMPORT&EXPORT CO.,LTD, NINGBO (CN)

(72) Inventor: Xu CHEN, NINGBO (CN)

(73) Assignee: NINGBO GALAXY IMPORT&EXPORT CO.,LTD, NINGBO (CN)

(21) Appl. No.: 17/182,255

(22) Filed: Feb. 23, 2021

(30) Foreign Application Priority Data
Dec. 21, 2020 (CN) 202023092741.7

(51) Int. Cl. F16B 2/10; C09D 175/04

(52) U.S. Cl. CPC F16B 2/10; C09D 175/04

(57) ABSTRACT

A clamp is provided. The clamp is formed by hinging two clamp arms; each clamp arm comprises a holding end, a clamping end and a connecting arm located between the holding end and the clamping end; the connecting arm is connected through a supporting shaft, and the supporting shaft is sleeved with a torsion spring; two pins of the torsion spring are respectively abutted against the inner side of the clamping end; an adsorption piece is arranged outside the clamping arm; and the adsorption piece is nano paste made of thermoplastic polyurethanes. The adsorption pieces manufactured from the nano paste made of thermoplastic polyurethanes. The adsorption pieces have strong adsorption force, can be adsorbed on objects of different materials, such as refrigerators, walls or wooden furniture, and have wide application range. The clamp is not limited by the material, is firmly clamped, and can be reused.

### TECHNICAL FIELD

The utility model relates to a clamp which is made of novel adsorption material and has a novel adsorption structure.

### BACKGROUND

The clamp is a common clamping component in daily life. For the convenience of hanging, a magnetic suction component is installed on the clip through improvement. The clamp can be fixed through the adsorption of the magnetic suction component. The magnetic suction component can only be adsorbed on a metal surface, and cannot be adsorbed on surfaces of walls and wooden furniture which cannot be adsorbed with magnets, so that use limitations are large. Therefore, a clamp that can be adsorbed on different material surfaces and repeatedly adsorbed and used is urgently needed.

### SUMMARY

The utility model provides a clamp, which is made of novel adsorption material and can be repeatedly adsorbed on various material surfaces and firmly clamped.

A technical solution adopted to solve the above technical problems in the utility model is as follows:

A clamp is provided. The clamp is formed by hinging two clamp arms; each clamp arm comprises a holding end, a clamping end and a connecting arm located between the holding end and the clamping end; the connecting arm is connected through a supporting shaft, and the supporting shaft is sleeved with a torsion spring; two pins of the torsion spring are respectively abutted against the inner side of the clamping end, wherein an adsorption piece is arranged outside the clamping arm, and the adsorption piece is nano paste made of thermoplastic polyurethanes.

Preferably, the inner side of the clamping end is provided with a plurality of teeth.

Preferably, the adsorption piece is square, circular, triangular or trapezoidal.

Compared with the prior art, the nano paste made of thermoplastic polyurethanes is arranged on the clamp arms of the clamp of the utility model as the adsorption pieces; the adsorption pieces have strong adsorption force, can be adsorbed on objects of different materials, such as refrigerators, walls or wooden furniture, and can be reused, with wide application range. The adsorption of the clamp is not limited by the material, and the clamping is firm.

### DESCRIPTION OF DRAWINGS

FIG. 1 is a three-dimensional schematic diagram of an embodiment 1 of a clamp of the utility model.

FIG. 2 is a main view of an embodiment 1 of a clamp of the utility model.

FIG. 3 is a three-dimensional schematic diagram of an embodiment 2 of a clamp of the utility model.

FIG. 4 is a main view of an embodiment 2 of a clamp of the utility model.

FIG. 5 is a three-dimensional schematic diagram of an embodiment 3 of a clamp of the utility model.

FIG. 6 is a rear view of an embodiment 3 of a clamp of the utility model.

FIG. 7 is a main view of an embodiment 3 of a clamp of the utility model.

FIG. 8 is a three-dimensional schematic diagram of an embodiment 4 of a clamp of the utility model.

FIG. 9 is a rear view of an embodiment 4 of a clamp of the utility model.

FIG. 10 is a main view of an embodiment 4 of a clamp of the utility model.

FIG. 11 is a three-dimensional schematic diagram of an embodiment 5 of a clamp of the utility model.

FIG. 12 is a rear view of an embodiment 5 of a clamp of the utility model.

FIG. 13 is a main view of an embodiment 5 of a clamp of the utility model.

FIG. 14 is a three-dimensional schematic diagram of an embodiment 6 of a clamp of the utility model.

FIG. 15 is a rear view of an embodiment 6 of a clamp of the utility model.

FIG. 16 is a main view of an embodiment 6 of a clamp of the utility model.

FIG. 17 is a three-dimensional schematic diagram of an embodiment 7 of a clamp of the utility model.

FIG. 18 is a rear view of an embodiment 7 of a clamp of the utility model.

FIG. 19 is a main view of an embodiment 7 of a clamp of the utility model.

FIG. 20 is a three-dimensional schematic diagram of an embodiment 8 of a clamp of the utility model.

FIG. 21 is a rear view of an embodiment 8 of a clamp of the utility model.

FIG. 22 is a main view of an embodiment 8 of a clamp of the utility model.

FIG. 23 is a three-dimensional schematic diagram of an embodiment 9 of a clamp of the utility model.

FIG. 24 is a rear view of an embodiment 9 of a clamp of the utility model.

FIG. 25 is a main view of an embodiment 9 of a clamp of the utility model.

FIG. 26 is a three-dimensional schematic diagram of an embodiment 10 of a clamp of the utility model.

FIG. 27 is a rear view of an embodiment 10 of a clamp of the utility model.

FIG. 28 is a main view of an embodiment 10 of a clamp of the utility model.

FIG. 29 is a three-dimensional schematic diagram of an embodiment 11 of a clamp of the utility model.

FIG. 30 is a rear view of an embodiment 11 of a clamp of the utility model.

FIG. 31 is a main view of an embodiment 11 of a clamp of the utility model.

### DETAILED DESCRIPTION

The utility model is further described below in detail in combination with the drawings and embodiments.

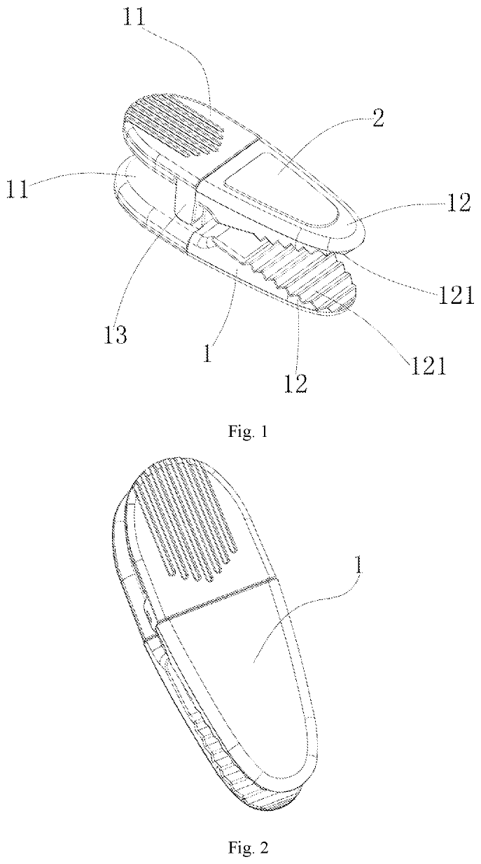

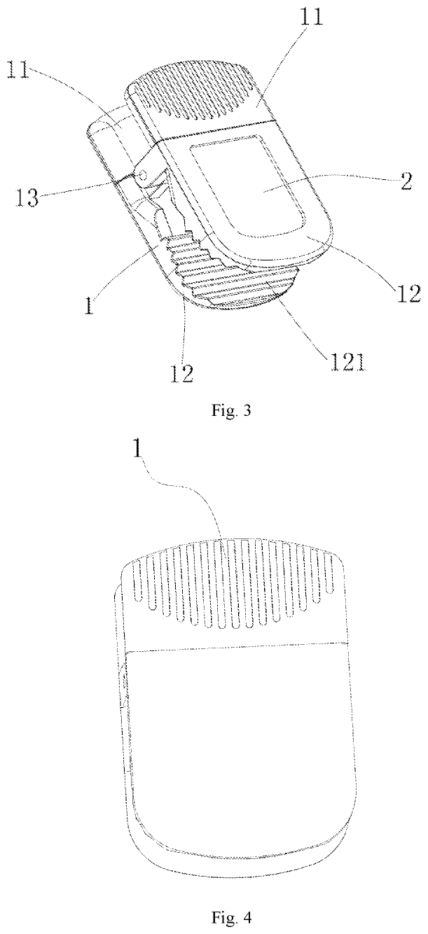

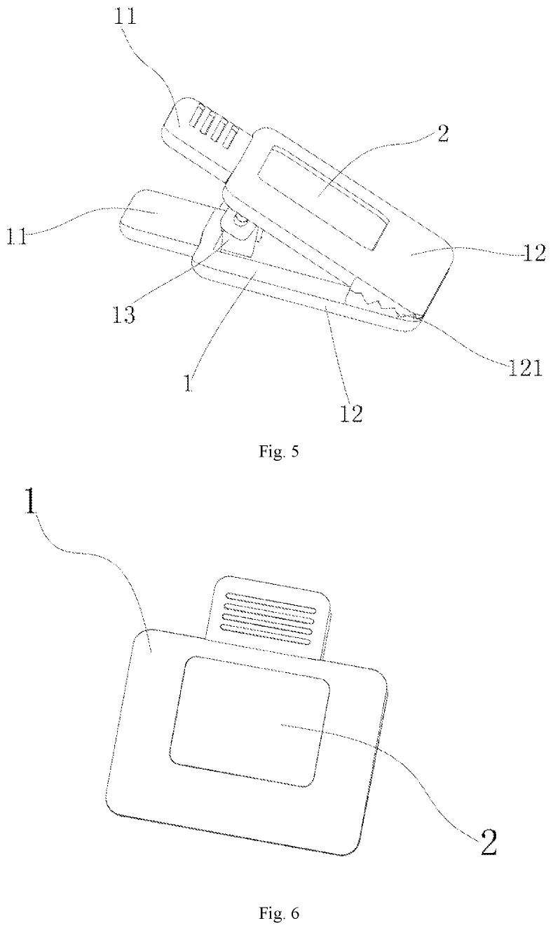

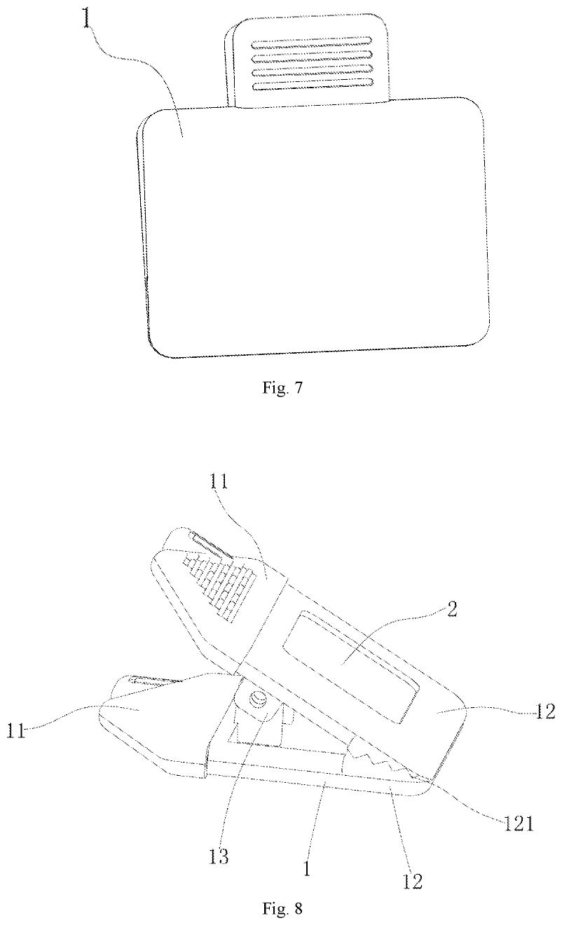

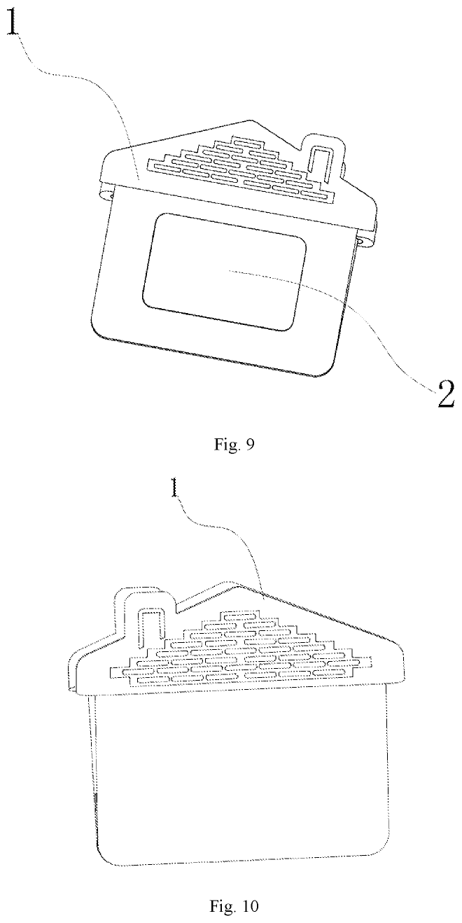

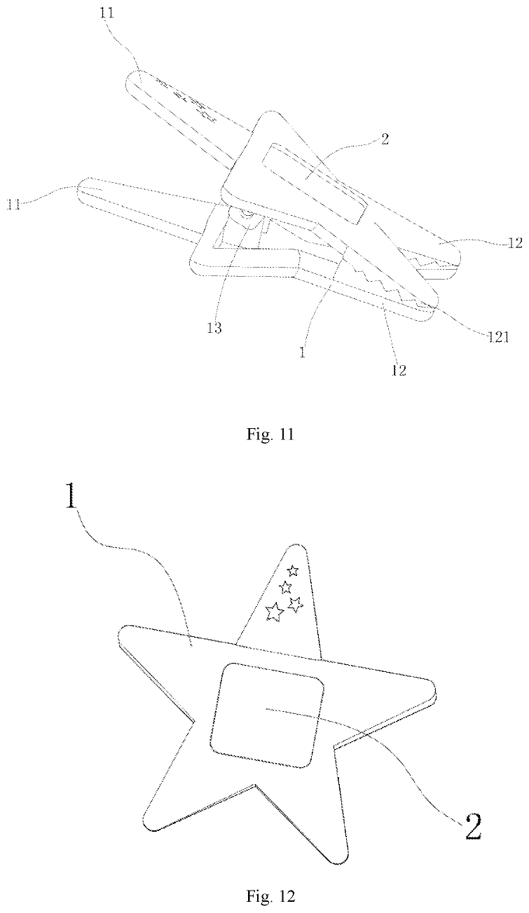

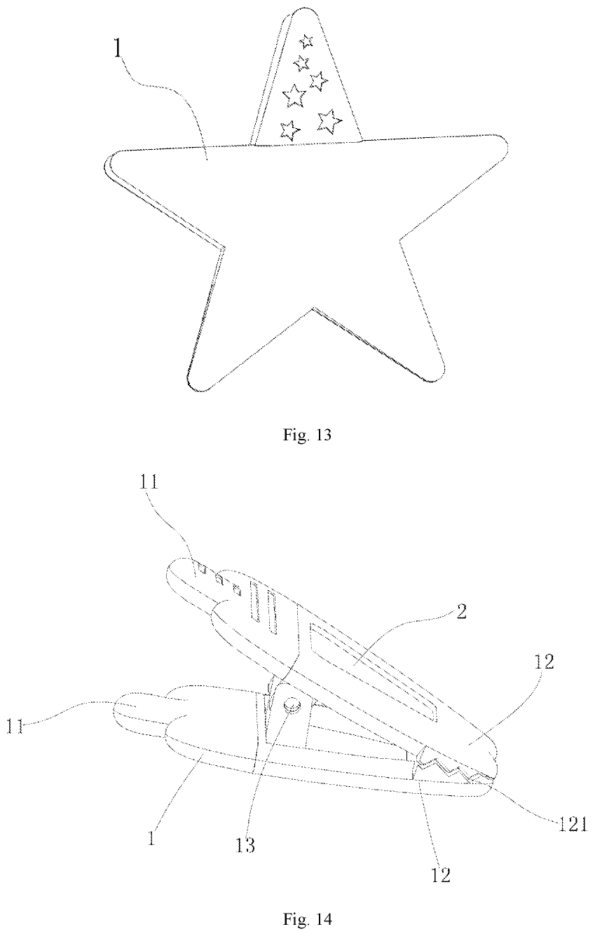

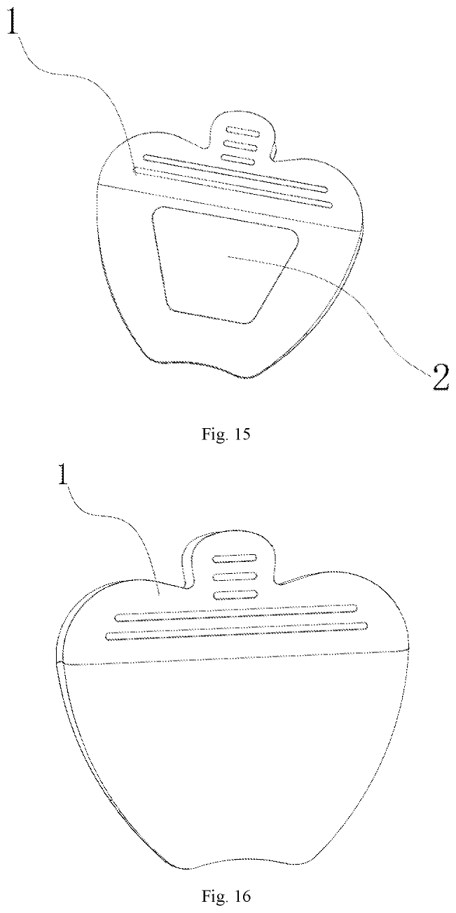

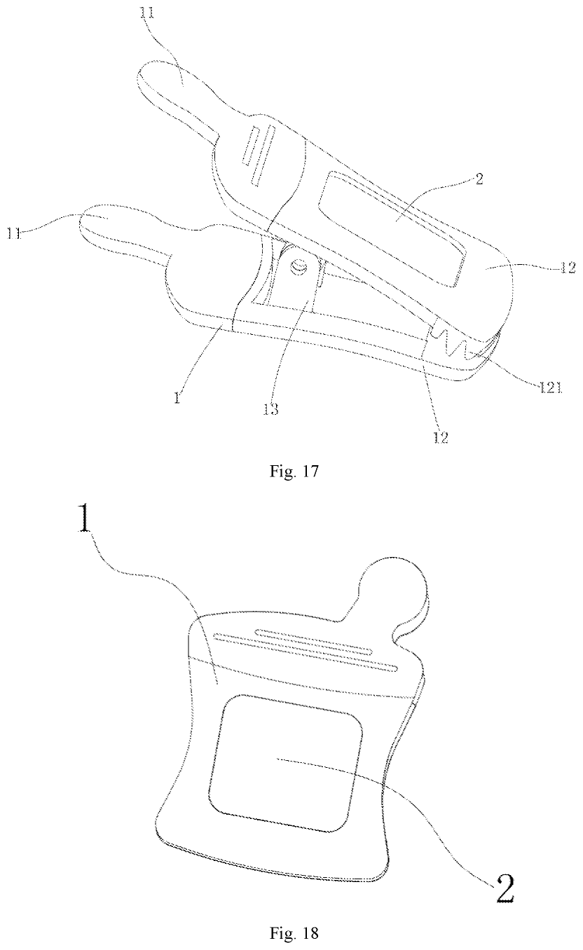

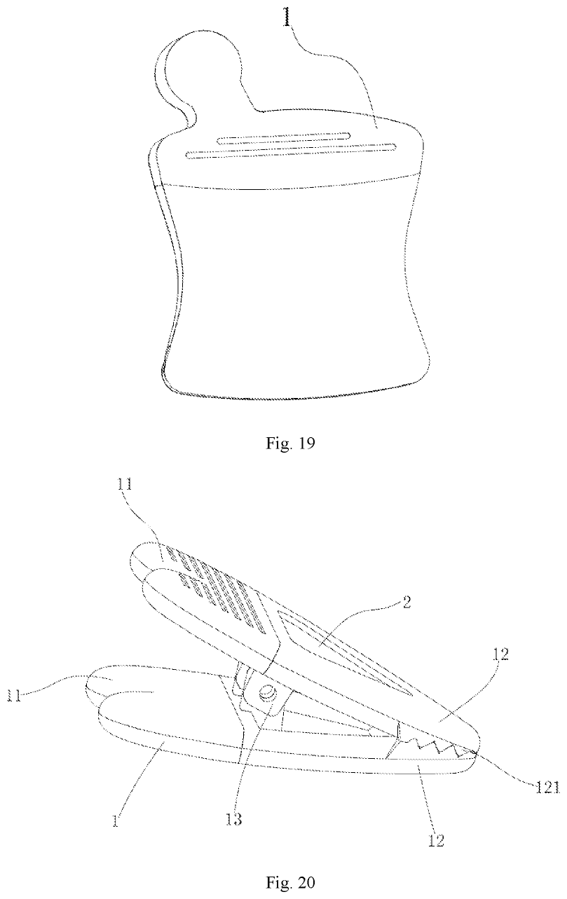

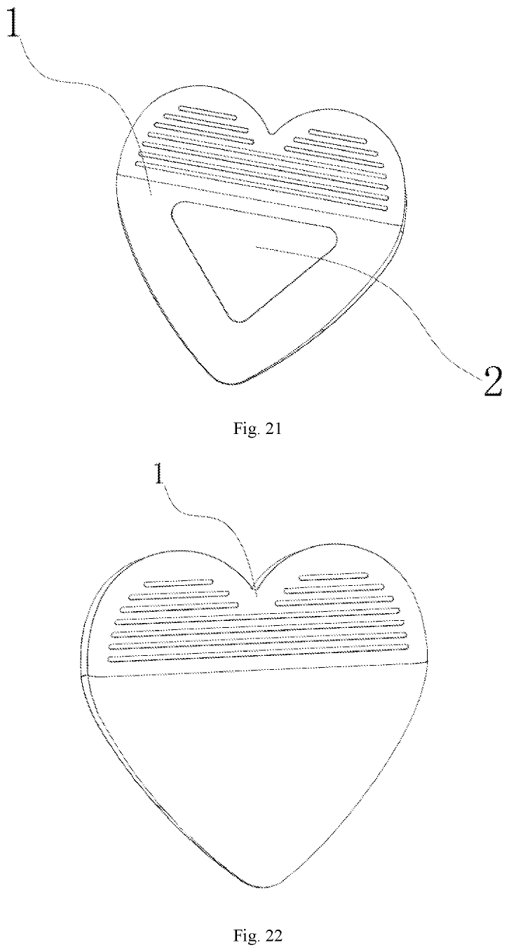

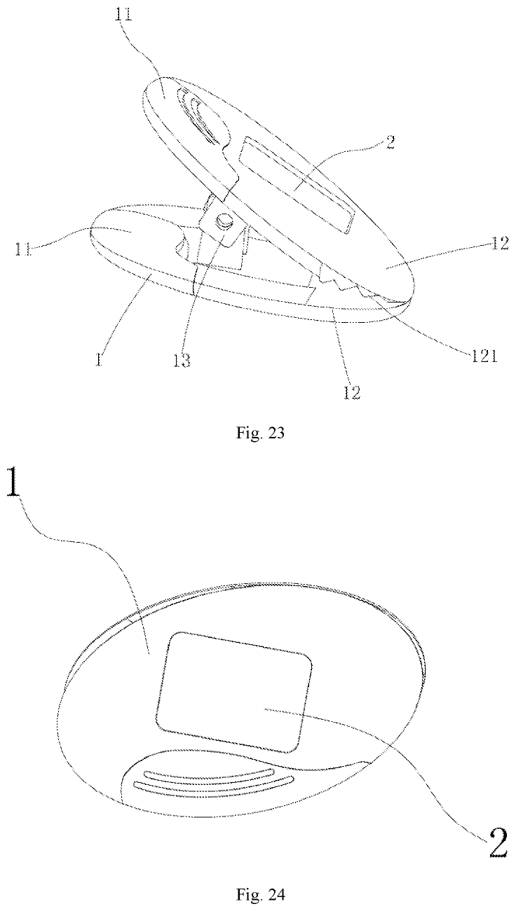

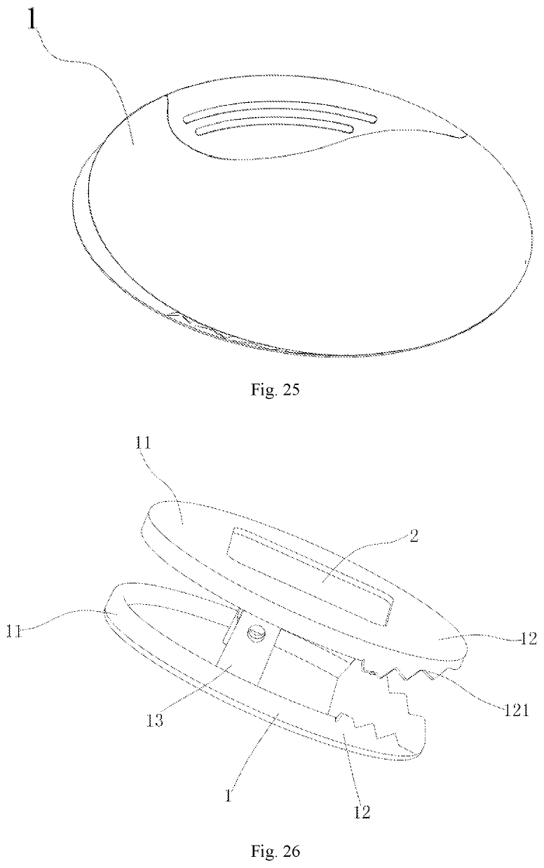

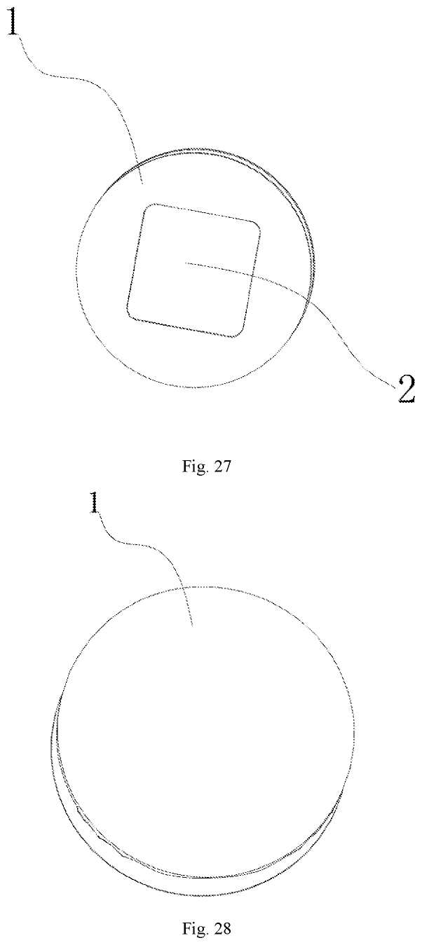

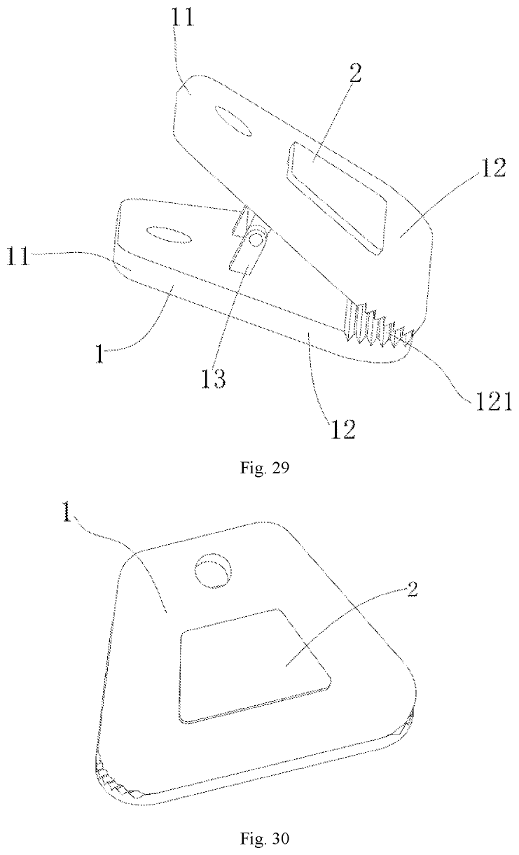

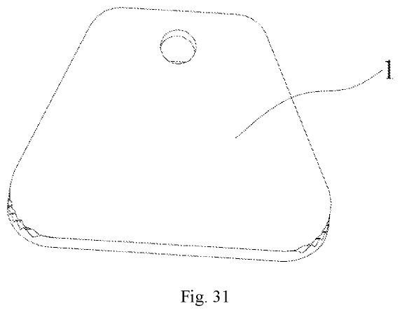

As shown in FIG. 1 to FIG. 31, a clamp has 11 different shapes, and each shape corresponds to one embodiment. The clamp is formed by hinging two clamp arms 1; each clamp arm 1 comprises a holding end 11, a clamping end 12 and a connecting arm 13 located between the holding end 11 and the clamping end 12; the connecting arm 13 is connected through a supporting shaft, and the supporting shaft is sleeved with a torsion spring; and two pins of the torsion spring are respectively abutted against the inner side of the clamping end 12.

The inner side of the clamping end 12 is provided with a plurality of teeth 121. Thus, the clamping end 12 increases the friction when clamping an object to prevent the object from slipping from the clamping end 12.

An adsorption piece 2 is arranged outside the clamping arm 1, and the adsorption piece 2 is nano paste made of thermoplastic polyurethanes. The thermoplastic polyurethanes nano paste is adsorbent rubber with polymer structure, and has the characteristics of high strength viscosity, high strength resistance to pull, high and low temperature resistance, washable property and repeated use. The adsorption piece 2 can be adsorbed on the wall and furniture, and can be reused without affecting the adsorption effect.

In the present embodiment, the adsorption piece 2 is square, circular, triangular or trapezoidal, and can also have other different shapes.

The nano paste made of thermoplastic polyurethanes is arranged on the clamp arms 1 of the clamp of the utility model as the adsorption pieces 2. The adsorption pieces 2 have strong adsorption force, can be adsorbed on objects of different materials, such as refrigerators, walls or wooden furniture, and have wide application range. The clamp is not limited by the material, is firmly clamped, and can be reused.

Finally, it should be noted that the above embodiments are only used for describing the technical solution of the utility model rather than limitation. Although the utility model is described in detail by referring to the above embodiments, those ordinary skilled in the art should understand that: the technical solution recorded in each of the above embodiments can be still amended, or some technical features therein can be replaced equivalently. However, these amendments or replacements do not enable the essence of the corresponding technical solution to depart from the spirit and the scope of the technical solution of various embodiments of the utility model.

What is claimed is:

1. A clamp, which is formed by hinging two clamp arms (1), wherein each clamp arm (1) comprises a holding end (11), a clamping end (12) and a connecting arm (13) located between the holding end (11) and the clamping end (12); the connecting arm (13) is connected through a supporting shaft, and the supporting shaft is sleeved with a torsion spring; two pins of the torsion spring are respectively abutted against the inner side of the clamping end (12), wherein an adsorption piece (2) is arranged outside the clamping arm (1), and the adsorption piece (2) is nano paste made of thermoplastic polyurethanes.

2. The clamp according to claim 1, wherein the inner side of the clamping end (12) is provided with a plurality of teeth (121).

3. The clamp according to claim 1, wherein the adsorption piece (2) is square, circular, triangular or trapezoidal.
